(19) United States
(12) Patent Application Publication
(10) Pub. No.: US 2009/0084366 A1
(43) Pub. Date: Apr. 2, 2009

(54) Method and System for Liquid Fuel Gasification

(75) Inventors: Igor A. Gachik, Boca Raton, FL (US); Lev M. Gurarye, Sunny Isles Beach, FL (US); Victor N. Gurin, Hollywood, FL (US); Yuri S. Levin, Weston, FL (US); Roman J. Press, Pitsford, NY (US); Naum Staroselsky, Sunny Isles Beach, FL (US); Sam Vaynblat, Coral Springs, FL (US)

Correspondence Address: LERNER GREENBERG STEMER LLP, P O BOX 2480, HOLLYWOOD, FL, 33022-2480, US

(73) Assignee: ULTIMATE COMBUSTION CORPORATION, Deerfield Beach, FL (US)

(21) Appl. No.: 11/863,455

(22) Filed: Sep. 28, 2007

(51) Int. Cl. F02M 23/00

(52) U.S. Cl. 123/585; 123/590

(57) ABSTRACT

A fuel is aerated in a fuel supply and gasification system for more efficient combustion in a combustion chamber. The gasification system includes a mixing device for mixing a liquid fuel with at least one gas. A gas source feeds the gas to a gas feeding nozzle and through the nozzle further to the mixing device, wherein the gas is mixed with the liquid fuel for forming a liquid fuel/gas bubbles mixture. A low-pressure fuel pump connected with the mixing device by a liquid fuel supply line feeds liquid fuel from a fuel reservoir to the mixing device at pressure P₁ higher than the gas pressure P₂. A prepared liquid fuel/gas bubbles mixture is fed into a high-pressure fuel pump where the liquid fuel/gas bubble mixture get compressed to the state of homogeneous liquid and further is injected into a combustion chamber for instance of internal combustion engine at a pressure P₄ that is higher than a pressure P₃ in the combustion chamber at the moment of injecting fuel in it. Finally, there is provided an electronic control system comprises electronic variable frequency pulse generator electrically connected with electrically operated gas feeding nozzle.

### BACKGROUND OF THE INVENTION

1. Field of the Invention

The present invention relates to liquid fuel gasification and, more particularly, to the dissolution of gasses under pressure in the liquid fuel and than injecting this solution into a combustion chamber, with the purpose of achieving high dispersion of the fuel in this combustion chamber of the reciprocating or gas turbine engine, or any other device having a combustion chamber.

It is common knowledge that the dispersion of a liquid fuel results in a highly developed active surface of this liquid fuel which allows to burn fuel more efficiently. The small size of the combustion chamber in a reciprocating engine, for example, results in partial deposition of the injected fuel on the piston and combustion chamber walls creating a liquid film on them. This part of fuel can not be burnt completely and is getting lost with exhaust. Uneven distribution of the liquid fuel particles over the volume of the combustion chamber causes a delay in the flame propagation, lowering the effectiveness of the combustion process—delivering less power. High dispersion of the fuel would allow avoiding these problems. Completely burnt fuel delivers more power, the temperature of its burning drops and amount of environment polluting exhaust gases (as NOₓ and CO₂) also diminishes with the drop of exhaust temperature.

There are different ways to provide dispersion of the liquid fuel, for instance with the help of fuel injectors or carburetors. Latest efforts in the area of fuel injection by the most prominent automotive engine building companies have resulted in the development of very high pressure injection systems—up to 2400 bar. On one hand this level of pressure is providing for very fine dispersion of fuel ensuring a significantly improved efficiency of the internal combustion engine but on another hand this level of pressure requires more reliable and more expensive technology.

There are known attempts to disperse fuel by dissolving some gas, for instance air or CO₂ in the liquid fuel and subsequently injecting this solution into the combustion chamber. When injected into the combustion chamber where pressure is lower than in the solution, dissolved gas get violently released from the solution, providing for very fine and uniform dispersion of the liquid fuel.

There exist quite a few patents, for instance U.S. Pat. Nos. 4,596,210; 6,273,072; and U.S. Pat. No. 7,011,048 which describe various devices and methods providing for the implementation of the described effect.

Commonly assigned patent U.S. Pat. No. 7,011,048 describes fuel a modification system which particularly comprises device for facilitating gas dissolution in the liquid fuel with help of highly developed absorbing surfaces created by corrugated inserts placed in specially design for this purpose vessel. Since the prepared in that vessel solution turned out saturated, after that it is subjected to compression with the help of high-pressure pump for preventing a development of gas bubbles in the solution, when it is further on its way to the combustion chamber. For the same purpose this fuel conditioning system is equipped with cooling device—according to Henry's Law, maximum concentration of gas in a gas/liquid solution goes up when pressure increases and when temperature decreases.

As was mentioned above, described embodiment requires specially designed device which is supposed to work in certain range of parameters (laminar flow rate of fuel and certain pressure of gas and fuel) to provide for proper dissolution of gas in liquid fuel, and, in the same time, these gas and liquid fuel supposed to have certain parameters for proper work of the combustion chamber feeding system. It is difficult to satisfy both of these requirements simultaneously.

### BRIEF SUMMARY OF THE INVENTION

It is accordingly an object of this invention to provide a method and apparatus which overcome the disadvantages of the prior art and which provide for further improvement in the fuel/gas solution injection into a combustion chamber.

With the above and other objects in view there is provided, in accordance with the invention, a fuel conditioning and combustion chamber injector feeding system, comprising:

a mixing device having a fuel inlet port, a gas inlet port, and an outlet port;

a fuel reservoir, a low-pressure fuel pump, and a liquid fuel supply line fluidically connected between said low-pressure fuel pump and said fuel inlet port of said mixing device for pumping fuel from said fuel reservoir to said mixing device;

a gas source and a gas pressure regulator;

a gas feeding nozzle and a gas supply line fluidically connected between said gas pressure regulator and said gas inlet port of said mixing device;

a high-pressure fuel pump fluidically connected with said outlet port of said mixing device; and

a fuel supply line fluidically connecting said high-pressure fuel pump with at least one fuel injector installed in the combustion chamber.

In other words, an internal combustion engine with a fuel supply system has a liquid fuel supply tank, a low-pressure fuel pump, a mixing device, a compressor (for air) or a gas supply tank (for air or CO₂), a gas feeding nozzle with a flow control means, a high-pressure fuel pump and a piping system, fluidically connecting all of the above. A pressure regulator controlling a pressure of gas supplied to the gas feeding nozzle is installed in line connecting the gas supply source—the gas tank (for air or CO₂) or the compressor (for air) with the gas feeding nozzle. A gas from gas supply source through the gas feeding nozzle and the liquid fuel from the low-pressure pump are both fed into the mixing device. That mixture of a gas in liquid fuel solution and gas bubbles is fed into the high-pressure fuel pump and a resulting homogeneous liquid is fed into the internal combustion engine. A recirculation line is provided for returning a fuel excess, pumped by the high-pressure fuel pump, back to the fuel inlet of the high-pressure fuel pump and a check valve is installed in the line between the mixing device and the high-pressure fuel pump to prevent a back flow of the fuel to the mixing device.

In accordance with an added feature of the invention, the high-pressure fuel pump is formed with a return port, and a return line for a liquid fuel/gas bubbles mixture is fluidically connected between said return port of said high-pressure fuel pump and an inlet port of said high-pressure fuel pump;

In accordance with an added feature of the invention, there is provided a gas flow volume feeding control system with an electronic pulse generator electrically connected with electrically controlled gas feeding nozzle.

In accordance with an added feature of the invention, the fuel pressure P₁ of said low-pressure fuel pump is set lower than a gas pressure P₂ at said gas feeding nozzle.

In accordance with an added feature of the invention, a gas flow control system comprises electronic variable frequency pulse generator electrically connected with an electrically operated gas feeding nozzle.

In accordance with an added feature of the invention, the high-pressure fuel pump is configured to generate a pressure higher than a pressure in the combustion chamber at a moment of injecting fuel in said combustion chamber.

With the above and other objects in view there is also provided, in accordance with the invention, a method of fuel gasification and feeding aerated fuel into a combustion process, the method which comprises:

providing a mixing device with a fuel inlet port connected to receive liquid fuel from a fuel source and a gas inlet port connected to receive a supply of a gas from a gas source, the gas source including pressure control means and having flow volume control means, and connecting the mixing device with a high-pressure fuel pump having an outlet port connected with at least one fuel injector at the combustion chamber;

feeding liquid fuel into the mixing device establishing working conditions in the mixing device for mixing the gas with the liquid fuel;

feeding a mixture of said liquid fuel and the gas into the high-pressure fuel pump, and compressing the mixture in the high-pressure fuel pump to a state of a substantially homogeneous liquid fuel; and

feeding the homogeneous liquid fuel into combustion chamber at a pressure P₄ higher then a pressure P₃ present in the combustion chamber at a moment of injecting fuel in the combustion chamber.

Other features which are considered as characteristic for the invention are set forth in the appended claims.

Although the invention is illustrated and described herein as embodied in method and system for liquid fuel gasification, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic view of the fuel system with recirculation line feeding excess of the aerated fuel back to the intake of the high pressure fuel pump; and

FIG. 2 is a diagrammatic view of the fuel system with recirculation line feeding excess of the conditioned fuel back to the intake of the mixing device, preferably injector.

### DETAILED DESCRIPTION OF THE INVENTION

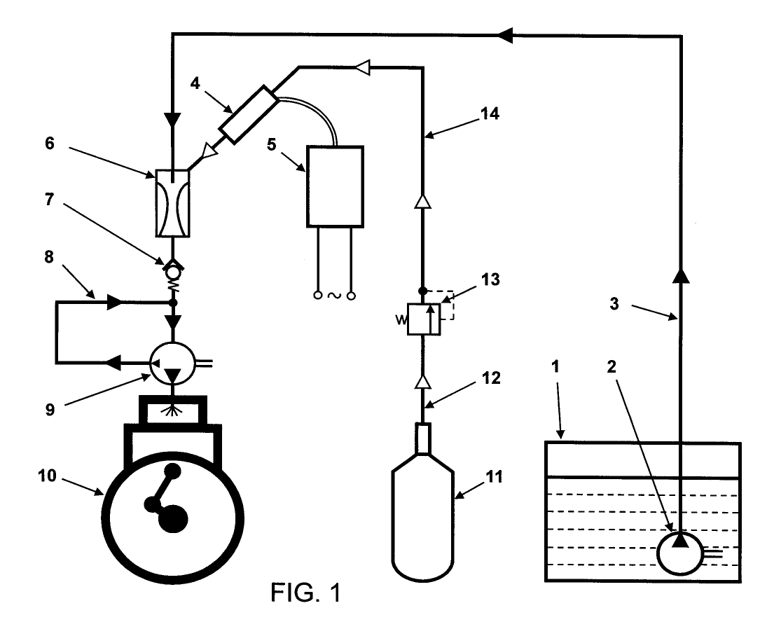

Referring now to the figures of the drawing in detail, the system of FIG. 1 includes a fuel tank 1, a low-pressure fuel pump 2 for delivering liquid fuel from the fuel tank 1 by way a fuel line 3 to a mixing device 6. Various mixing devices are known in the prior art. The low-pressure fuel pump provides a fuel pressure P₁. A source of a compressed gas 11 (for instance air or CO₂) is fluidically connected by way of a line 12 to the inlet of a pressure reducer 13 for controlling pressure of a gas at a level P₂ downstream of the pressure reducer 13 in a line 14. An outlet of the pressure reducer 13 is fluidically connected by a line 14 to the inlet of a gas feeding nozzle 4. The gas pressure P₂ downstream of the pressure reducer 13 is higher than the fuel pressure P₁, created by the low-pressure fuel pump 2 at the level, providing satisfactory working condition for the mixing device 6. An outlet of the mixing device 6 is fluidically connected to an inlet of a high-pressure fuel pump 9. The high-pressure fuel pump 9 is provided for feeding fuel into an internal combustion engine 10. Since the high-pressure fuel pump 9 is capable of delivering much bigger volume of the fuel than can be consumed at the same time by the internal combustion engine 10, in one embodiment a recirculation line 8 is provided for return of the fuel excess back to the inlet of the high-pressure fuel pump 9 and a check valve 7 is installed to prevent this fuel from going back to the mixing device 6.

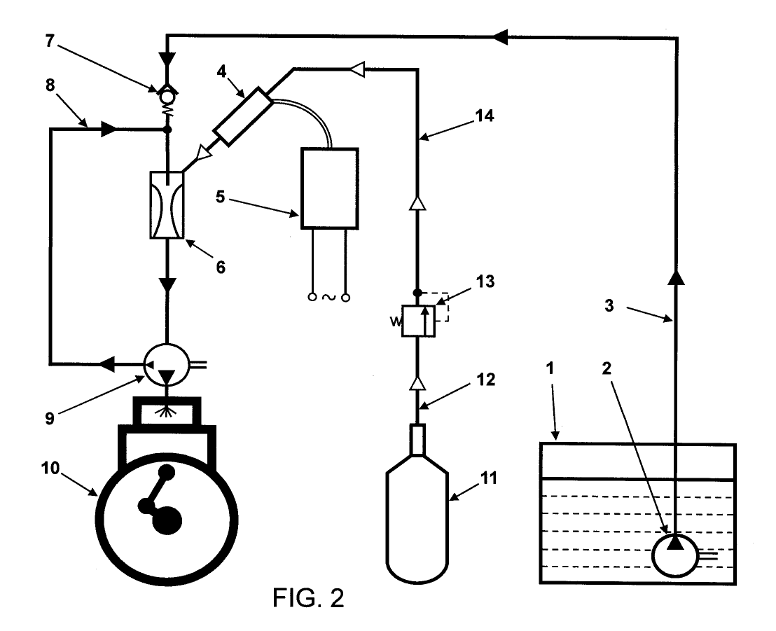

Referring now to FIG. 2, which illustrates a modified embodiment, a recirculation line 8 is provided for the return of the fuel excess back to the inlet of the mixing device 6 and a check valve 7 is installed to prevent this fuel from going back to the low-pressure fuel pump 2. In the preferred embodiment a gas flow control system consists of a pulse generator 5 electrically connected with the electrically operated gas feeding nozzle 4.

The liquid fuel is pumped by the low-pressure fuel pump 2 into the mixing device 6. The compressed gas (for instance air or CO₂) is delivered from the gas tank 11 (in case of using CO₂) or air compressor to the gas feeding nozzle 4 and through it to the same mixing device 6. The pressure of gas P₂ is set higher (or equal) than the pressure P₁ provided by the low-pressure fuel pump 2, guarantying satisfactory working conditions of the injector 6. A flow volume control of the gas going through the gas feeding nozzle 4 is provided by controlling a frequency of an electric impulses opening a valve of the gas feeding nozzle. These impulses are generated by the pulse generator 5 electrically connected to the electrically operated gas feeding nozzle 4. The mixture of liquid solution and bubbles created in the mixing device 6 is delivered to the high-pressure fuel pump 9, where it is get compressed to the state of homogeneous liquid solution, and is further injected in the combustion chamber of the internal combustion engine 10. Since the pressure in the injected liquid solution is higher than the pressure in the combustion chamber of the internal combustion engine 10, dissolved in the liquid solution gas violently escapes from the liquid, breaking it in very small liquid fuel particles, providing for particles even distribution over the volume of the combustion chamber and for the speedy propagation of the burning front. This way fuel is having burnt before it could reach walls of the combustion chamber and bottom of the piston of the internal combustion engine where otherwise it would create cold film on the surfaces. Faster and more efficiently burnt fuel delivers more energy, so it takes less fuel to produce the same amount of power.

1. A fuel conditioning and combustion chamber injector feeding system, comprising:
a mixing device having a fuel inlet port, a gas inlet port, and an outlet port;
a fuel reservoir, a low-pressure fuel pump, and a liquid fuel supply line fluidically connecting said low-pressure fuel pump and said fuel inlet port of said mixing device for pumping fuel from said fuel reservoir to said mixing device;
a gas source and a gas pressure regulator;
a gas feeding nozzle and a gas supply line fluidically connecting said gas pressure regulator and said gas inlet port of said mixing device;
a high-pressure fuel pump fluidically connected with said outlet port of said mixing device; and
a fuel supply line fluidically connecting said high-pressure fuel pump with at least one fuel injector installed in the combustion chamber.

2. The system according to claim 1, wherein said high-pressure fuel pump is formed with a return port, and a return line for a liquid fuel/gas bubbles mixture is fluidically connecting said return port of said high-pressure fuel pump and an inlet port of said high-pressure fuel pump;

3. The system according to claim 1, which comprises a gas flow volume feeding control system with an electronic pulse generator electrically connected with electrically controlled gas feeding nozzle.

4. The system according to claim 1, wherein a fuel pressure P₁ of said low-pressure fuel pump is set lower than a gas pressure P₂ at said gas feeding nozzle.

5. The system according to claim 1, wherein a gas flow control system comprises electronic variable frequency pulse generator electrically connected with an electrically operated gas feeding nozzle.

6. The system according to claim 1, wherein said high-pressure fuel pump is configured to generate a pressure higher than a pressure in the combustion chamber at a moment of injecting fuel in said combustion chamber.

7. A method of fuel gasification and feeding aerated fuel into a combustion process, the method which comprises:
(a) providing a mixing device with a fuel inlet port connected to receive liquid fuel from a fuel source and a gas inlet port connected to receive a supply of a gas from a gas source, the gas source including pressure control means and having flow volume control means, and connecting the mixing device with a high-pressure fuel pump having an outlet port connected with at least one fuel injector at the combustion chamber;
(b) feeding liquid fuel into the mixing device establishing working conditions in the mixing device for mixing the gas with the liquid fuel;
(c) feeding a mixture of said liquid fuel and the gas into the high-pressure fuel pump, and compressing the mixture in the high-pressure fuel pump to a state of a substantially homogeneous liquid fuel; and
(d) feeding the homogeneous liquid fuel into combustion chamber at a pressure P₄ higher then a pressure P₃ present in the combustion chamber at a moment of injecting fuel in the combustion chamber.

8. The method according to claim 7, which comprises feeding excess fuel/gas mixture, by way of a return line, back to an inlet port of the high-pressure fuel pump.

9. The method according to claim 7, which comprises feeding excess fuel/gas mixture, by way of a return line, back to an inlet port of the mixing device.

10. The method according to claim 7, which comprises controlling a gas flow volume by volume control means in the form of an electronic pulse generator electrically connected to with electrically controlled gas feeding nozzle.

11. The method according to claim 7, which comprises setting a fuel pressure P₁ of the low-pressure fuel pump lower than a gas pressure P₂ for providing satisfactory working conditions for performing a mixing of the at least one gas with the liquid fuel in the mixing device.

12. The method according to claim 7, wherein a level of a gas concentration in solution exceeds a solution saturation level for conditions present in the combustion chamber at a moment of injection.

13. In an internal combustion engine fuel delivery system, including a fuel injection system for injecting into a combustion chamber of the internal combustion engine, a fuel conditioning system, comprising:
a mixing device having a fuel inlet port, a gas inlet port, and an outlet port;
a fuel reservoir, a low-pressure fuel pump, and a liquid fuel supply line fluidically connecting said low-pressure fuel pump and said fuel inlet port of said mixing device for pumping fuel from said fuel reservoir to said mixing device;
a gas source and a gas pressure regulator;
a gas feeding nozzle and a gas supply line fluidically connecting said gas pressure regulator and said gas inlet port of said mixing device;
a high-pressure fuel pump fluidically connected with said outlet port of said mixing device; and
a fuel supply line fluidically connecting said high-pressure fuel pump with at least one fuel injector installed in said combustion chamber.

14. The fuel delivery system according to claim 13, which further comprises a liquid fuel/gas bubbles mixture return line connecting a return port of said high-pressure fuel pump and said inlet port of said high-pressure fuel pump.

15. The fuel delivery system according to claim 13, which further comprises a liquid fuel/gas bubbles mixture return line connecting a return port of said high-pressure fuel pump and said inlet port of said mixing device.

16. The fuel delivery system according to claim 13, which comprises a gas flow volume feeding control system with electronic variable frequency pulse generator electrically connected with electrically operated gas feeding nozzle.
